(19) United States
(12) Patent Application Publication
(10) Pub. No.: US 2026/0221689 A1
(43) Pub. Date: Jul. 30, 2026

(54) CONNECTOR HOUSING

(71) Applicant: SMK Corporation, Tokyo (JP)

(72) Inventors: Toshimitsu TAKEDA, Toyama (JP); Takanobu MAKIMURA, Toyama (JP); Mieko TSUJIKADO, Toyama (JP); Masayuki TANIGUCHI, Toyama (JP)

(21) Appl. No.: 19/452,843

(22) Filed: Jan. 19, 2026

(30) Foreign Application Priority Data
Jan. 27, 2025 (JP) 2025-011123

(51) Int. Cl. H01R 13/627; H01R 13/631; H01R 13/641

(52) U.S. Cl. CPC H01R 13/6275; H01R 13/631; H01R 13/641; H01R 2201/26

(57) ABSTRACT

A connector housing engageable with and disengageable from a mating housing includes a main body, a housing lever supported by the main body, and a slide lever. The housing lever has a support portion supported by the main body, and an arm extending from the support portion in an engagement direction and formed flexurally displaceable. An operation portion and the arm are supported by the support portion, and are swingable in a seesaw manner. The tip end of the arm has an engagement portion. In a state in which the slide lever is attached at an engagement position, elastic deformation in which the arm is flexed in a separating direction is performed along with contact between the engagement portion and an interference target portion of the mating housing. At the time of engagement with the mating housing, the arm hits the mating housing to emit engagement completion sound.

### DESCRIPTION

The contents of the following patent application(s) are incorporated herein by reference:

NO. 2025-011123 filed in JP on January 27, 2025.

### Field

The present invention relates to a housing of a connector.

### BACKGROUND

Patent Literature 1 discloses a related connector.

### Prior Art Document

### Patent Literature

Patent Literature 1: JP-A-2006-318844

### SUMMARY

This connector includes a first housing provided with a lock arm, and a second housing fittable in the first housing. In a process of fitting both the housings, the lock arm is elastically flexed due to interference between a lock portion provided in the lock arm and a lock portion provided in the second housing, and when both the housings reach a regular fitting state, the lock arm is elastically restored to bring the lock portions into a lock state, whereby both the housings are locked in a separation restriction state. The lock arm is provided, in rear of a leg portion, with an elastic flexure portion to be elastically flexed due to contact with the first housing in a state in which the lock portions interfere with each other, and when both the housings are regularly fitted and the lock arm is elastically restored, the lock arm stores not only an elastic restoring force due to elastic flexure of the lock arm itself, but also an elastic restoring force due to elastic flexure of the elastic flexure portion, so that collision sound (engagement completion sound) between the housing and the lock arm is amplified accordingly.

However, in order to amplify the collision sound generated by the elastic flexure portion, the elastic flexure portion to be elastically flexed is also required to have equivalent thickness and size, which hinders a demand for reduction in the size of the connector.

An object of an aspect the present invention is to provide a connector housing capable of solving the above-described problems and emitting sufficient collision sound only by elastic flexure of a lock arm.

The connector housing of an aspect of the present invention is

a housing of a connector engageable with and disengageable from a mating housing, which includes

a main body, a housing lever supported by the main body, and a slide lever.

The housing lever includes

a support portion supported by the main body,

an operation portion extending from the support portion in a direction opposite to an engagement direction, and

an arm extending from the support portion in the engagement direction and formed flexurally displaceable,

the operation portion and the arm are supported by the support portion, and are swingable in a seesaw manner,

the tip end of the arm has an engagement portion,

the slide lever

includes a restricting portion disposed on the side of the operation portion in a support portion forming direction and configured to restrict displacement of the operation portion in the support portion forming direction, and

a main body contact portion disposed on the side of the operation portion in the support portion forming direction, and

is attached to the main body so as to be movable in the engagement direction and a disengagement direction between an engagement position at which the main body contact portion contacts the opposing surface of the main body and a disengageable position at which the main body contact portion does not contact the surface,

in a state in which the slide lever is attached at the engagement position and displacement of the operation portion in the support portion forming direction is restricted, swing displacement of the arm due to displacement of the engagement portion in a separating direction away from an interference target portion of the mating housing, which is the direction opposite to the support portion forming direction, along with contact between the engagement portion and the interference target portion is restricted, so that the arm is elastically deformed to flex in the separating direction,

when an engagement target portion of the mating housing and the engagement portion are engaged with each other, a collision portion at the tip end of the arm hits the mating housing by a restoring force of the elastic deformation to emit engagement completion sound,

the slide lever has a slide lever operation portion,

when the slide lever operation portion is pressed down in the support portion forming direction in a state in which displacement of the operation portion in the support portion forming direction is not restricted by the slide lever being attached at the disengageable position, the operation portion is displaced in the support portion forming direction, the arm is displaced (swingably displaced) in the direction opposite to the support portion forming direction, and both the housings are disengaged from each other, and

when the slide lever is attached at the disengageable position, a distance L1 between the support portion and the operation portion and a distance L2 between the support portion and the slide lever operation portion is L1 < L2.

According to the connector housing of an aspect the present invention, in a state in which the slide lever is attached at the engagement position and displacement of the operation portion in the support portion forming direction is restricted in the engagement operation with the mating housing, displacement of the operation portion in the support portion forming direction is restricted. Thus, swing displacement of the arm is restricted, elastic deformation in which only the arm is flexed in the separating direction is performed, and the engagement completion sound based on the restoring force of elastic deformation of the arm can be emitted when engagement is completed. Since the distance L2 from the support portion to the slide lever operation portion is longer than the distance L1 between the support portion and the operation portion (L1 < L2) when the slide lever is attached at the disengageable position, an effect of obtaining a lighter operation feeling in the disengagement operation than in a case of simply pressing the operation portion is obtained.

### BRIEF DESCRIPTION OF DRAWINGS

FIG. 1 is a perspective view of a connector and a mating connector housing of an aspect of the present invention;

FIG. 2 is a perspective view of a main body and a housing lever of the connector of an aspect of the present invention;

FIG. 3 is a side view of the connector main body and the housing lever of an aspect of the present invention;

FIG. 4 is a perspective view of a slide lever of an aspect of the present invention;

FIG. 5 is a perspective view of the slide lever of an aspect of the present invention;

FIG. 6 is a side view of the connector housing of an aspect of the present invention;

FIG. 7 is a view of the connector housing of an aspect of the present invention from a side in an engagement direction;

FIG. 8 is a view of the connector housing of an aspect of the present invention from a side in a disengageable direction;

FIG. 9 is a view of the connector housing of an aspect of the present invention from above;

FIG. 10 is a sectional view of the connector housing of an aspect of the present invention from above;

FIG. 11 is a sectional view showing a state before engagement between the connector housing and the mating housing of an aspect of the present invention;

FIG. 12 is a sectional view showing a state in the middle of engagement between the connector housing and the mating housing of an aspect of the present invention;

FIG. 13 is a sectional view showing the state of engagement between the connector housing and the mating housing of an aspect of the present invention;

FIG. 14 is a sectional view showing a state in which the slide lever is moved from an engagement position to a disengageable position in the state of the connector housing and the mating housing of an aspect of the present invention; and

FIG. 15 is a sectional view showing the state of disengagement between the connector housing and the mating housing of an aspect of the present invention.

### DESCRIPTION OF EMBODIMENTS

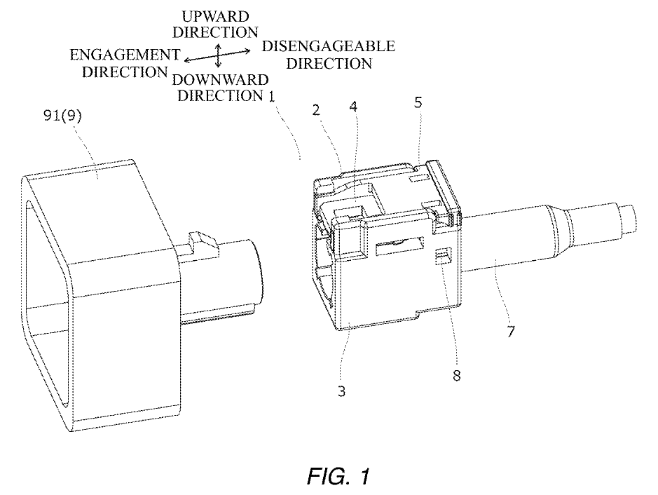

Hereinafter, a housing 2 of a connector 1 according to an embodiment of an aspect of the present invention will be described with reference to the drawings. Note that an aspect of the present invention is not limited to the embodiment described below, and various changes can be made without departing from the gist of an aspect of the present invention. The present embodiment is a preferred specific example of an aspect of the present invention, and the contents of an aspect of the present invention are not limited to the following embodiment. Note that in the following description, an engagement direction may be referred to as a forward direction, a disengageable direction may be referred to as a rearward direction, a support portion forming direction may be referred to as a downward direction, a direction opposite to the support portion forming direction may be referred to as an upward direction, and a direction from a near side to a far side and vice versa in FIG. 1 may be collectively referred to as a left-right direction.

FIG. 1 is a perspective view when the connector 1 of the present embodiment and a mating housing 91 which is a housing of a mating connector 9 face each other. The housing 2 of the present embodiment is the housing 2 of the connector 1 engageable with and disengageable from the mating housing 91. Upon use, an electric wire 7 can be inserted into the housing 2 as in FIG. 1. The position of the electric wire 7 is fixed by a retainer 8. Note that the mating housing 91 in the present embodiment is a rear housing of an in-vehicle camera module, and the mating housing 91 and the mating connector 9 are integrally formed.

The housing 2 has a main body 3, a housing lever 4 supported by the main body 3, and a slide lever 5. The main body 3, housing lever 4, and slide lever 5 of the housing 2 are each made of synthetic resin.

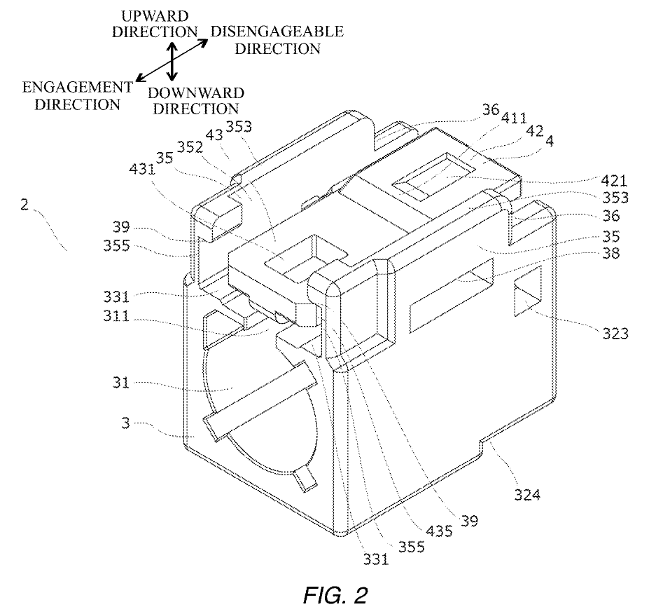

FIG. 2 is a perspective view of the main body 3 and the housing lever 4 of the present embodiment.

The main body 3 has a substantially rectangular parallelepiped shape, and has a step 324 in the downward direction. The main body 3 has, on the side in the engagement direction, a substantially circular mating housing insertion port 31 into which a hood portion 92 of the mating housing 91 is to be inserted and a cutout 311 through which an engagement target portion 921 of the mating housing 91 passes. The shape of the mating housing insertion port 31 is a shape corresponding to the hood portion 92 of the mating housing 91 described later.

The main body 3 has, on the side in the disengageable direction, a substantially circular electric wire insertion port 32 communicating with the mating housing insertion port 31, a retainer insertion port 322 communicating with each insertion port and formed for the retainer 8 for fixing the electric wire 7, and retainer windows 323, 323 for fixing the retainer. The shape of the electric wire insertion port 32 is a shape corresponding to the shape of the electric wire 7. An electric wire contact portion 321 used for positioning the electric wire 7 may be provided inside the electric wire insertion port 32. The retainer insertion port 322 is provided in the step 324 of the main body 3.

Further, the main body 3 has, in the upward direction and the engagement direction, a surface 331 on which slide surfaces 553, 553 of the slide lever 5 described later are slidable, and on the side in the upward direction and the disengageable direction, has a surface 332 with which main body contact portions 558, 558 of the slide lever 5 described later contact. Provided between the surface 331 and the surface 332 is a surface 333 disposed in the downward direction with respect to the surface 331 and the surface 332.

In the upward direction of the main body 3, there are provided a support portion 34 that supports the housing lever 4 described later and two opposing wall portions 35, 35 on both the left and right sides of the housing lever 4.

Each of the wall portions 35, 35 has an inner wall 352, 352 facing inward of the housing 2, an outer wall 351, 351 facing outward, a top surface 353, 353 facing the upward direction, a front surface 355, 355 facing forward, and a rear surface 354, 354 facing rearward.

Each of the inner walls 352, 352 has, on the side in the engagement direction, a slide restricting portion 36, 36 having a shape in which the top surface 353, 353 and the rear surface 354, 354 are partially cut out and configured to restrict slide of the slide lever 5 described later.

Each of the inner walls 352, 352 has a groove 371, 371 through which a guide target portion 555, 555 described later passes and a protruding wall 372, 372 over which the guide target portion 555, 555 passes, and also has a guide portion 38, 38 having a guide protrusion 381, 381, a guide wall 382, 382, and a guide restricting portion 383, 383 and communicating with the outer wall 351, 351.

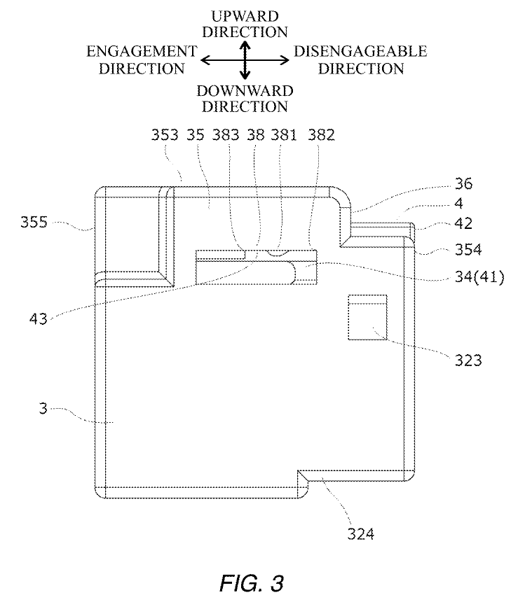

FIG. 3 is a side view of the main body 3 and the housing lever 4. The guide portion 38, 38 is disposed near the support portion 34, and the support portion 34 is disposed between the guide wall 382, 382 and the guide protrusion 381, 381.

Each of the inner walls 352, 352 has, on the side in the disengageable direction, a lifting restricting portion 39, 39 that restricts lifting of a slide arm 55, 55 described later. The lifting restricting portion 39, 39 is disposed on the side in the disengageable direction with respect to the support portion 34 in each of the inner walls 352, 352.

The housing lever 4 has a support portion 41 supported by the main body 3, an operation portion 42 extending from the support portion 41 in the direction opposite to the engagement direction, and an arm 43 extending from the support portion 41 in the engagement direction and formed flexurally displaceable.

In the present embodiment, the support portion 34 and the support portion 41 are the same as each other. The support portion 34 protrudes in the upward direction from the main body 3. The support portion 41 has, in the upward direction, a restricting target portion 411 contactable with a flexure restricting portion 53 described later. The restricting target portion 411 is provided at a position facing the slide lever 5 between the arm 43 and the operation portion 42. Note that the flexure restricting portion 53 and the restricting target portion 411 described later can constantly contact each other regardless of whether the slide lever 5 is at an engagement position or a disengageable position.

The operation portion 42 has, in the surface thereof in the upward direction, a slide recess 421, and in the surface thereof in the downward direction, has ribs 423, 423 provided on both the left and right sides and protruding in the downward direction.

The operation portion 42 and the arm 43 are supported by the support portion 34 and swingable in a seesaw manner, and the arm 43 has, at the tip end thereof, an engagement portion 432.

The arm 43 has an opening 431 penetrating the arm 43 in the up-down direction. The engagement portion 432 is disposed on the side of the opening 431 in the engagement direction. The engagement portion 432 has, on the side in the engagement direction, an interference portion 433 corresponding to an interference target portion 922 of the mating housing 91, and on the side in the downward direction, has a collision portion 434 capable of hitting the mating housing 91 to emit engagement completion sound.

Side walls 435, 435 are provided on both the left and right sides of the arm 43, respectively. The arm 43 has, on the lower side, a lower surface 436.

In the present embodiment, the main body 3 and housing lever 4 of the connector 1 are integrated (single component), but the main body 3 and the housing lever 4 may be separated from each other. Hereinafter, the main body 3 and the housing lever 4 may be collectively referred to as a main body portion.

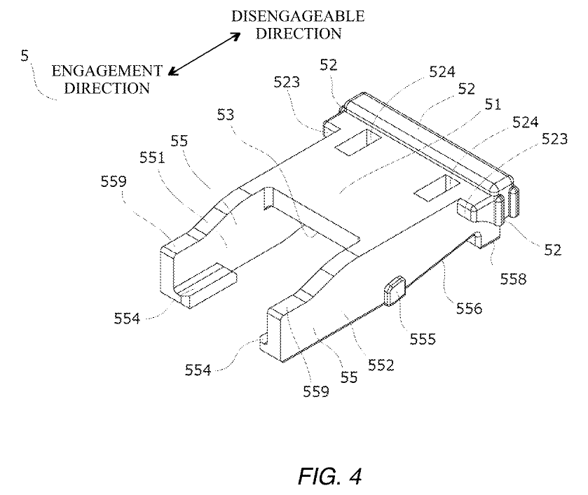

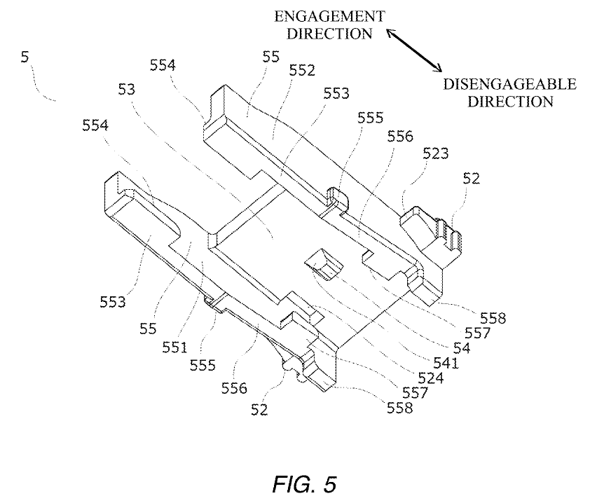

FIGS. 4 and 5 are perspective views of the slide lever 5. The slide lever 5 is an inverted U-shaped component when viewed from the side in the engagement direction. The slide lever 5 has the two opposing slide arms 55, 55 protruding in a plate shape from a substantially flat plate-shaped portion 51 toward both the left and right sides in the downward direction and the engagement direction. Each of the slide arms 55, 55 has an inner wall 551, 551, an outer wall 552, 552, an upper surface 559, 559 facing the upward direction, and the slide surface 553, 553 facing the downward direction. The outer walls 552, 552 face the inner walls 352, 352 of the wall portions 35, 35 of the main body 3, respectively.

Each of the inner walls 551, 551 has, on the side in the engagement direction, a lifting portion 554, 554 protruding in a plate shape in a direction of the inner walls 551, 551 facing each other, respectively. The lifting portions 554, 554 are disposed on the side of the arm 43 in the support portion forming direction when assembled to the main body portion.

Each of the outer walls 552, 552 has the guide target portion 555, 555 protruding in a substantially quadrangular shape. The plate-shaped portion 51 has, on the side in the disengageable direction, a slide lever operation portion 52 protruding in the upward direction and to both the left and right sides.

Each of the slide arms 55, 55 has a restricting portion 557, 557 disposed on the side of the operation portion 42 in the support portion forming direction and configured to restrict displacement of the operation portion 42 in the support portion forming direction, and the main body contact portion 558, 558 disposed on the side of the operation portion 42 in the support portion forming direction. The restricting portions 557, 557 protrude inward of both the slide arms 55, 55 on the left and right side and the side of the slide lever operation portion 52 in the downward direction. The main body contact portions 558, 558 protrude in the downward direction from the slide arms 55, 55. Each of the slide arms 55, 55 has, in the downward direction, a stopper 556, 556 inclined from the guide target portion 555, 555 to the slide lever operation portion 52.

The plate-shaped portion 51 has contact-stoppers 523, 523 on the left and right sides, which extend from end portions of the plate-shaped portion 51 on the side in the disengageable direction toward the side in the engagement direction. The plate-shaped portion 51 has, on the side in the disengageable direction, holes 524, 524 formed on the side of the restricting portions 557, 557 in the upward direction. The plate-shaped portion 51 has, in the downward direction, the flexure restricting portion 53 contactable with the restricting target portion 411, and a slide protrusion 54 slidable in the slide recess 421.

The mating housing 91 is a housing of the mating connector 9 engageable with and disengageable from the connector 1 of the present embodiment. The mating housing 91 has the hood portion 92 protruding in a substantially circular shape, the engagement target portion 921 protruding in the upward direction from the hood portion 92, and a collision target portion 923 corresponding to the collision portion 434. The shape of the hood portion 92 is a shape corresponding to the mating housing insertion port 31. The engagement target portion 921 has the interference target portion 922 corresponding to the interference portion 433.

The mating housing 91 is the rear housing of the in-vehicle camera module, and has an opening 93 for housing a circuit board (not shown) inside the mating housing 91. The mating connector 9 is electrically connected to a connector (not shown) mounted on the circuit board in a state in which the circuit board is housed inside the mating housing 91 and assembled as the camera module. That is, by connecting the connector 1 and the mating connector 9, the electric wire 7 and the circuit board inside the mating housing 91 are electrically connected to each other.

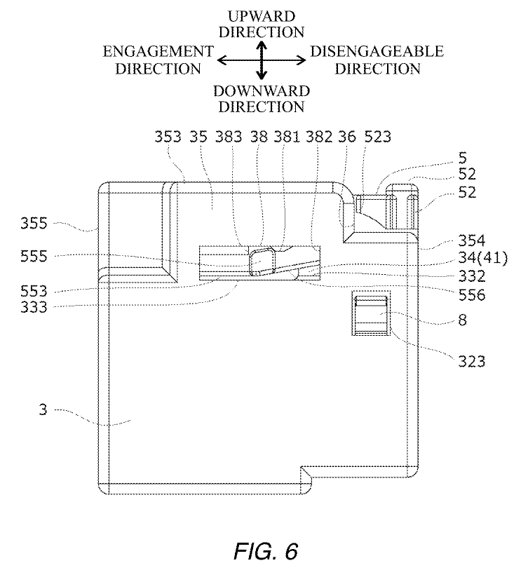

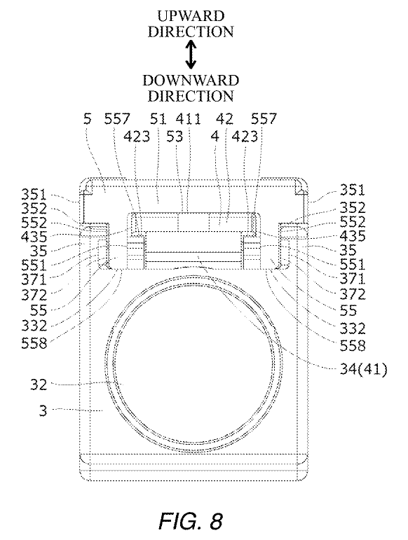

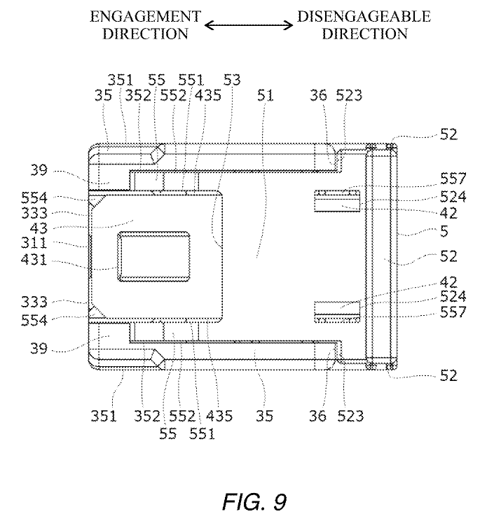

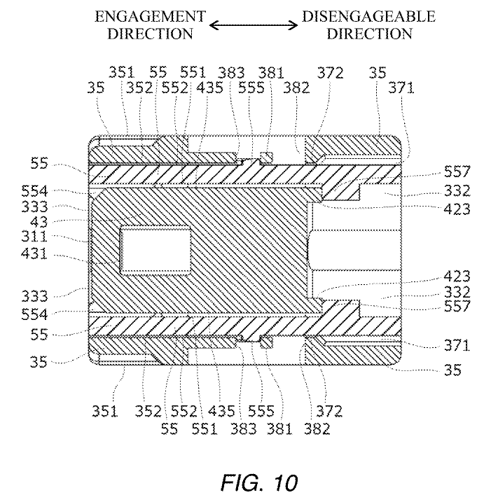

The features of the present embodiment will be described. First, the slide lever 5 is attached to the main body portion. FIGS. 6 to 10 are views of the connector housing of an aspect of the present invention, and show a state in which the slide lever 5 is attached to the main body portion.

Each slide surface 553, 553 of the slide lever 5 slides on the surface 332 in a state of these surfaces facing each other, and the slide lever 5 is inserted from the side (side in the disengageable direction) of the main body portion in the rearward direction to the side (side in the engagement direction) in the forward direction such that each slide arm 55, 55 is inserted between the inner wall 352, 352 of each wall portion 35, 35 of the main body portion and each side wall 435, 435 of the housing lever 4.

When the guide target portions 555, 555 pass the protruding walls 372, 372 through the left and right grooves 371, 371, the slide lever 5 is attached at the disengageable position. When the guide target portions 555, 555 pass the protruding walls 372, 372, sound or an operation feeling may be provided. Further, when each slide surface 553, 553 of the slide lever 5 slides on the surface 331 in a state of these surfaces facing each other and each guide target portion 555, 555 passes the guide protrusion 381, 381, the slide lever 5 is attached at the engagement position. When the guide target portions 555, 555 pass the guide protrusions 381, 381, sound or an operation feeling may be provided. At the engagement position, the guide target portion 555, 555 is disposed between the guide restricting portion 383, 383 and the guide protrusion 381, 381. The guide restricting portion 383, 383 restricts movement of the guide target portion 555, 555 in the engagement direction.

As shown in FIG. 6, in a state in which the slide lever 5 is attached at the engagement position, the slide lever 5 and the surface 333 does not contact each other. When the slide lever 5 is slid to the disengageable position described later, the slide lever 5 can move in the downward direction, so that the guide target portion 555, 555 can pass over the guide protrusion 381, 381. Alternatively, in the slide movement to the disengageable position, the slide arm 55, 55 may be bent inward of the connector 1, so that the guide target portion 555, 555 can pass over the guide protrusion 381, 381.

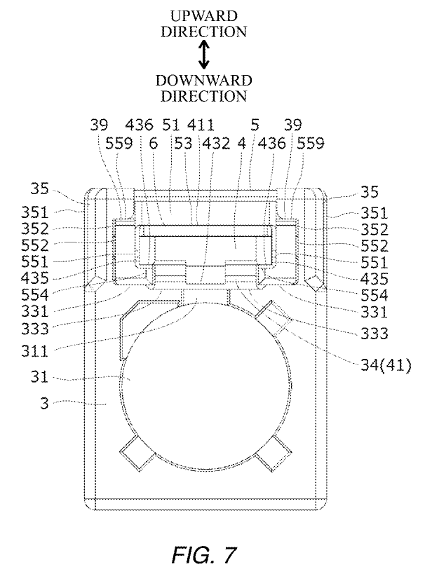

As shown in FIGS. 7 to 10, since the opposing inner walls 352, 352 of each wall portion 35, 35 and the outer walls 552, 552 are disposed in parallel, the slide lever 5 is movable in the engagement direction and the disengageable direction. Alternatively, since the side walls 435, 435 of the housing lever 4 and the inner walls 551, 551 are disposed in parallel, the slide lever 5 is movable in the engagement direction and the disengageable direction.

Since the guide target portion 555, 555 is attached movable in the guide portion 38, 38, movement of the slide lever 5 in the engagement direction and the disengageable direction is restricted, and dropping of the slide lever 5 from the main body portion is prevented. The slide protrusion 54 and a wall 422 of the slide recess 421 may contact each other, so that dropping of the slide lever 5 from the main body portion can be prevented.

When the slide lever 5 is attached at the engagement position, the slide restricting portions 36, 36 and the contact-stoppers 523, 523 of the slide lever 5 face each other, so that further excessive push-in of the slide lever 5 in the engagement direction can be prevented.

In a state in which the slide lever 5 is attached, the slide lever 5 is attached to the main body 3 so as to be movable in the engagement direction and the disengagement direction between the engagement position at which the main body contact portions 558, 558 contact the opposing surface 332 of the main body 3 and the disengageable position at which the main body contact portions 558, 558 do contact the surface 332.

Specifically, in a case where the slide lever 5 is attached at the engagement position, the guide target portion 555, 555 is on the side in the engagement direction with respect to the guide protrusion 381, 381 of the guide portion 38, 38, when viewed from the side of the connector 1. Each restricting portion 557, 557 is contactable with the rib 423, 423. An end portion of the operation portion 42 and an end portion of the slide lever operation portion 52 are substantially at the same position on the side in the disengageable direction. In other words, a distance L1 between the support portion 34 and the operation portion 42 and a distance L2 between the support portion 34 and the slide lever operation portion 52 are substantially the same as each other. The restricting target portion 411 is contactable with the side of the flexure restricting portion 53 in the disengageable direction, and has a space 6 (clearance) between the upper surface of the arm 43 and the flexure restricting portion 53. The restricting target portion 411 and a flat surface 541 of the slide protrusion 54 are contactable with each other. Further, the surface 332 of the main body 3 and the main body contact portions 558, 558 are contactable with each other. Since the surface 332 of the main body 3 and the main body contact portions 558, 558 contact each other, when the slide lever 5 is attached at the engagement position, displacement of the operation portion 42 in the support portion forming direction is restricted.

Further, the electric wire 7 is inserted through the electric wire insertion port 32. The electric wire insertion port 32 includes therein the electric wire contact portion 321 to define the position of the inserted electric wire 7. Further, the retainer 8 (not shown) is inserted through the retainer insertion port 322 to fix the electric wire 7 to the connector 1. Note that the retainer insertion port 322 and the retainer windows 323, 323 may be omitted as long as it is not necessary to fix the electric wire 7 by the retainer 8. In the following description, the electric wire 7 and the retainer 8 will be omitted.

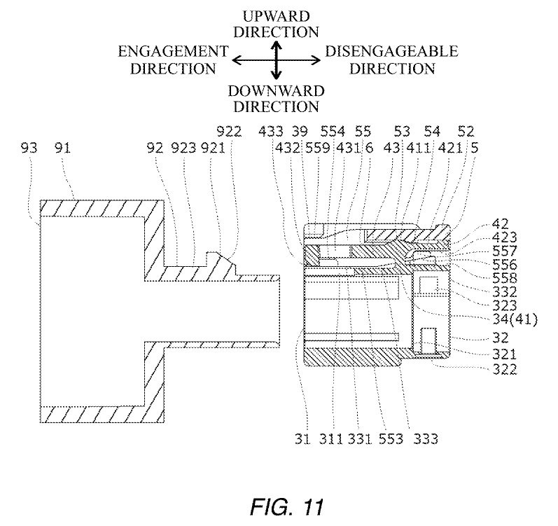

FIGS. 11 to 13 are views for describing an operation of fitting the housing 2 (connector 1) and the mating housing 91 (mating connector 9) in each other. As shown in FIG. 11, a process of causing the housing 2 and the mating housing 91 to face each other such that the engagement portion 432 and the engagement target portion 921 face each other and engaging both the housings with each other from this state will be described below.

At the time of the start of engagement, the slide lever 5 is attached at the engagement position, and displacement of the operation portion 42 in the support portion forming direction is restricted. When the mating housing 91 and the housing 2 are brought close to each other with a hand or the like with both the housings facing each other, the hood portion 92 is inserted into the mating housing insertion port 31. When both the housings are further brought close to each other, as the interference portion 433 of the engagement portion 432 and the interference target portion 922 of the engagement target portion 921 of the mating housing 91 come into contact with each other, the engagement portion 432 tends to be displaced in a direction away from the interference target portion 922, which is the direction opposite to the support portion forming direction.

In this case, since the lower rib 423, 423 of the operation portion 42 and the restricting portion 557, 557 contact each other and the main body contact portion 558, 558 and the surface 332 of the main body 3 contact each other, the operation portion 42 cannot be displaced in the downward direction as swing displacement corresponding to displacement of the arm 43 in the upward direction. That is, since the swing displacement of the arm 43 is restricted, the arm 43 is elastically deformed so as to be flexed in the upward direction which is the separating direction.

As the arm 43 elastically deforms, the flexure restricting portion 53 and the restricting target portion 411 contact each other, so that deformation of the support portion 34 is regulated by the flexure restricting portion 53. In the present embodiment, deformation of the support portion 34 is more reliably restricted by bringing the flexure restricting portion 53 and the flat surface 541 of the restricting target portion 411 into contact with each other. As a result, a load on the support portion 34 due to elastic deformation of the arm 43 is not concentrated. Thus, even in a case where the support portion 34 is formed thin, the arm 43 can be elastically deformed without bending or deformation of the support portion 34. Deformation of the support portion 34 and the like can also be prevented by the lower rib 423, 423 of the operation portion 42 and the restricting portion 557, 557 contacting each other. Note that instead of the rib 423, 423, the lower surface of the operation portion 42 and the restricting portion 557, 557 may directly contact each other. By standing the rib 423, 423, the strength of the operation portion 42 can be further enhanced even in a case where the thickness of the operation portion 42 is small.

Even in a case where the operation portion 42 is pressed by pressing the slide lever operation portion 52 in the downward direction, displacement of the operation portion 42 is restricted, and the operation portion 42 cannot be displaced in the downward direction. Moreover, since the lifting restricting portions 39, 39 disposed above the upper surfaces 559, 559 of both the slide arms 55, 55 contact the upper surfaces 559, 559, the arm 43 cannot be lifted by the lifting portions 554, 554.

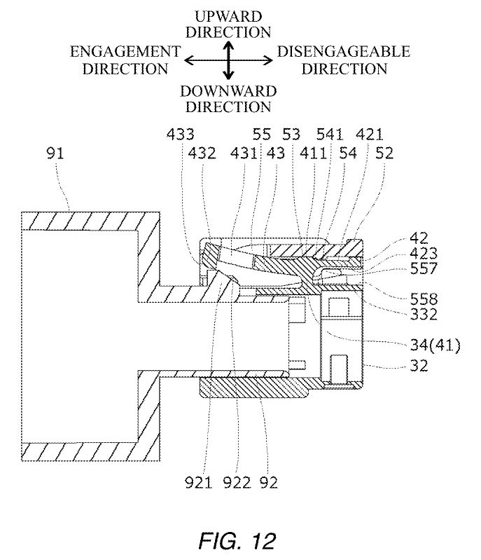

FIG. 12 shows a state in the middle of engagement between the housing 2 and the mating housing 91 when the arm 43 is elastically deformed. Since the space 6 is provided between the flexure restricting portion 53 and the arm 43, even if the arm 43 is elastically deformed in the engagement process, such elastic deformation is not interfered. In this state, a large restoring force for returning the engagement portion 432 to an original state is accumulated in the arm 43.

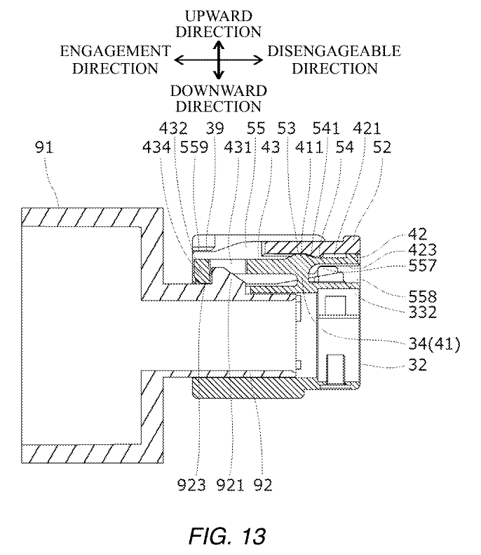

When the engagement process progresses and the engagement portion 432 completely passes over the engagement target portion 921, as shown in FIG. 13, the engagement portion 432 of the housing 2 and the engagement target portion 921 of the mating housing 91 are engaged with each other, that is, at least part of the engagement target portion 921 is disposed in an internal space of the opening 431. When the state of FIG. 12 described above is changed to the state of FIG. 13, that is, at the moment when engagement between the engagement target portion 921 of the mating housing 91 and the engagement portion 432 is completed, the collision portion 434 at the tip end of the arm 43 hits the collision target portion 923 of the mating housing 91 by the restoring force of the elastic deformation and emits the engagement completion sound. At this time, as described above, since a large restoring force is accumulated in the arm 43, the collision portion 434 strongly hits the collision target portion 923, and emits large engagement completion sound.

As described above, in the engagement process, large engagement completion sound can be emitted when the engagement is completed. In order to obtain larger engagement completion sound, it has been common to obtain large collision sound by increasing the strength by securing the thicknesses and sizes of the support portion 34 and the operation portion 42 supporting the arm 43. On the other hand, in the present embodiment, since the elastic deformation is concentrated on the arm 43, it is not necessary to increase the strengths of the support portion 34 and the operation portion 42 more than necessary. Thus, the support portion 34 and the operation portion 42 can be reduced in thickness or size, which contributes to reduction in the size of the connector 1.

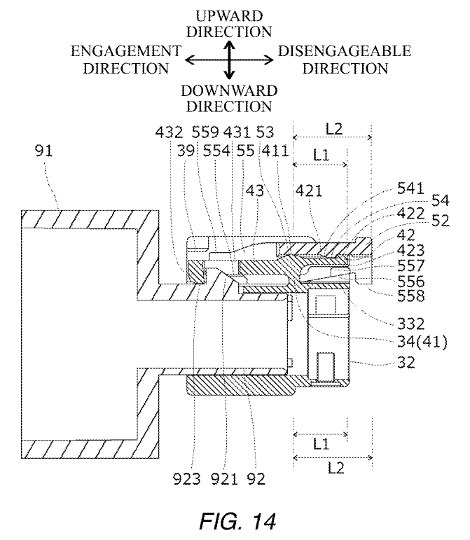

The slide lever 5 can be slid from the engagement position in the disengageable direction to be disposed at the disengageable position as shown in FIG. 14. The slide operation of the slide lever 5 can be performed by pulling the slide lever operation portion 52 in the disengageable direction with a finger, a jig, or the like. The slide surfaces 553, 553 and the surface 331 slide in a state of facing each other by the slide operation. The guide target portions 555, 555 move in the disengageable direction in the guide portions 38, 38, and pass under the guide protrusions 381, 381. When the guide target portions 555, 555 pass the guide protrusions 381, 381, sound or an operation feeling may be provided. A state in which the guide target portions 555, 555 are disposed between the guide protrusions 381, 381 and the guide walls 382, 382 is a state in which the slide lever 5 is attached at the disengageable position.

In a case where the slide lever 5 is attached at the disengageable position, the end portion of the operation portion 42 and the end portion of the slide lever operation portion 52 are at different positions on the side in the disengageable direction as viewed from the side of the connector 1. In other words, the distance L1 between the support portion 34 and the operation portion 42 and the distance L2 between the support portion 34 and the slide lever operation portion 52 are L1 < L2. The restricting portions 557, 557 are contactable with the ribs 423, 423. The restricting target portion 411 can contact the side of the flexure restricting portion 53 in the engagement direction. The lower surface of the plate-shaped portion 51 and a surface 424 of the operation portion 42 can contact each other. The slide protrusion 54 can contact the wall 422 of the slide recess 421. The surface 332 of the main body 3 and the main body contact portions 558, 558 do not contact each other.

Since the slide lever 5 is attached at the disengageable position, displacement of the operation portion 42 in the support portion forming direction is not restricted. The guide target portion 555, 555 is disposed between the guide wall 382, 382 and the guide protrusion 381, 381.

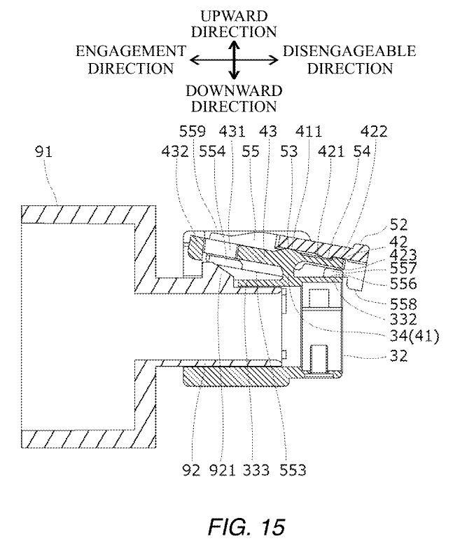

By pressing the slide lever operation portion 52 in the support portion forming direction from this state, the slide lever 5 rotates with a line (not shown) connecting the left and right guide target portions 555, 555 as a rotation axis in such a direction that the slide lever operation portion 52 is displaced in the downward direction and the slide arms 55, 55 are displaced in the upward direction. As a result, the operation portion 42 pressed by the slide lever operation portion 52 is displaced in the downward direction which is the support portion forming direction with the support portion 34 substantially on the rotation axis as the point of support, and the arm 43 is displaced (swingably displaced) in the upward direction which is the direction opposite to the support portion forming direction, so that both the housings are disengaged from each other (FIG. 15). In this state, both the housings can be pulled out and detached. Since the engagement portion 432 and the engagement target portion 921 can be detached without damage thereto, both the housings can be reused.

By pressing the slide lever operation portion 52 in the downward direction, the lifting portions 554, 554 protruding from the tip ends of the slide arms 55, 55 and disposed in the downward direction with respect to the arm 43 are displaced in the upward direction, and the lower surface 436 of the arm 43 is lifted. In this manner, the arm 43 is also reliably displaced in the upward direction at the time of disengagement.

Since the distance L2 from the support portion 34 to the slide lever operation portion 52 is longer than the distance L1 between the support portion 34 and the operation portion 42, a lighter operation feeling is obtained in the disengagement operation than in a case of simply pressing the operation portion 42. Since the distance L2 between the support portion 34 and the slide lever operation portion 42 is longer than the distance L1 between the support portion 34 and the operation portion 52, for example, even in a case where the length of the operation portion 42 to the side in the disengageable direction is short and the disengagement operation cannot be performed only with the operation portion 42, the disengagement can be performed by the pressing operation of the slide lever operation portion 52.

By pressing the slide lever operation portion 52 in the support portion forming direction by a certain amount or more, the stoppers 556, 556 contact the surface 332 of the main body 3 facing the stoppers 556, 556, and displacement of the operation portion 42 in the pressing direction is restricted. Thus, the damage to the connector 1 due to excessive press-down of the slide lever operation portion 52 is prevented at the time of disengagement.

When the operation portion 42 is displaced in the downward direction in a state in which the slide lever 5 is attached at the disengageable position, the flexure restricting portion 53 and the restricting target portion 411 contact each other and displacement of the support portion 34 is restricted, so that the arm 43 can be swingably displaced without bending or deformation even if the support portion 34 is thin. Further, even when the restricting portions 557, 557 and the slide lever operation portion 52 sandwich the operation portion 42 from above and below, deformation of the support portion 34 and the like can be prevented. Since the disengagement operation can be performed regardless of the strengths of the support portion 34 and the operation portion 42, the operation portion 42 can be reduced in thickness or size, which contributes to reduction in the size of the connector 1.

Although the embodiment of an aspect of the present invention has been specifically described above, an aspect of the present invention is not limited to the above-described embodiment, and various modifications based on the technical idea of an aspect of the present invention can be made.

In the above-described embodiment, the example where each component is made of synthetic resin has been described, but there may be a component made of a material other than the synthetic resin, for example, an alloy. In a case where the main body 3 and the housing lever 4 are separated from each other, another component may be added for connection between the support portion 34 and the support portion 41. The guide target portion may be on the main body side, and the groove and the guide portion may be on the slide lever side. Although the example where the shapes and structures of the connector 1, the housing 2, the main body 3, the housing lever 4, and the slide lever 5 are substantially bilaterally symmetrical has been described, there may be a portion which is not bilaterally symmetrical.

In the above-described embodiment, the example where the mating housing 91 is the rear housing of the in-vehicle camera module has been described, but the mating housing 91 is not limited thereto, and for example, can be suitably applied to various connectors such as a connector provided for a housing other than that of the camera module, a cable relay connector, and a receptacle connector mounted on a circuit board.

An aspect of the present invention is not limited to the configurations, methods, steps, shapes, materials, and the like of the embodiment described above, and these configurations and the like can be combined or exchanged by a person having ordinary knowledge in the art without departing from the gist of an aspect of the present invention. It is also possible to divide one component into two or more components, or to combine two or more components into one component. It is also possible to omit some components. The contents of an aspect of the present invention are not to be construed as being limited by the effects described in the present specification.

### REFERENCE SIGNS LIST

1: Connector

2: Housing

3: Main body

4: Housing lever

5: Slide lever

6: Space

7: Electric wire

8: Retainer

9: Mating connector

1. A housing of a connector engageable with and disengageable from a mating housing, comprising:
a main body; a housing lever supported by the main body; and a slide lever,
wherein the housing lever includes
a support portion supported by the main body,
an operation portion extending from the support portion in a direction opposite to an engagement direction, and
an arm extending from the support portion in the engagement direction and formed flexurally displaceable,
the operation portion and the arm are supported by the support portion, and are swingable in a seesaw manner,
a tip end of the arm has an engagement portion,
the slide lever
includes a restricting portion disposed on a side of the operation portion in a support portion forming direction and configured to restrict displacement of the operation portion in the support portion forming direction, and
a main body contact portion disposed on the side of the operation portion in the support portion forming direction, and
is attached to the main body so as to be movable in the engagement direction and a disengagement direction between an engagement position at which the main body contact portion contacts an opposing surface of the main body and a disengageable position at which the main body contact portion does not contact the surface,
in a state in which the slide lever is attached at the engagement position and displacement of the operation portion in the support portion forming direction is restricted, swing displacement of the arm due to displacement of the engagement portion in a separating direction away from an interference target portion of the mating housing, which is a direction opposite to the support portion forming direction, along with contact between the engagement portion and the interference target portion is restricted, so that the arm is elastically deformed to flex in the separating direction,
when an engagement target portion of the mating housing and the engagement portion are engaged with each other, a collision portion at a tip end of the arm hits the mating housing by a restoring force of the elastic deformation to emit engagement completion sound,
the slide lever has a slide lever operation portion,
when the slide lever operation portion is pressed down in the support portion forming direction in a state in which displacement of the operation portion in the support portion forming direction is not restricted by the slide lever being attached at the disengageable position, the operation portion is displaced in the support portion forming direction, the arm is displaced (swingably displaced) in the direction opposite to the support portion forming direction, and both the housings are disengaged from each other, and
when the slide lever is attached at the disengageable position, a distance L1 between the support portion and the operation portion and a distance L2 between the support portion and the slide lever operation portion is L1 < L2.

2. The connector housing according to claim 1, wherein
the slide lever has a flexure restricting portion,
the housing lever has a restricting target portion at a position facing the slide lever between the arm and the operation portion,
the flexure restricting portion and the restricting target portion are constantly contactable with each other regardless of whether the slide lever is at the engagement position or the disengageable position, and
the flexure restricting portion and the restricting target portion come into contact with each other along with elastic deformation of the arm in a state in which the slide lever is attached at the engagement position.

3. The connector housing according claim 2, wherein
a space is provided between the flexure restricting portion and the arm.

4. The connector housing according to claim 1, wherein
the slide lever has a stopper, and
when the slide lever operation portion is pressed down in the support portion forming direction, the stopper and a surface of the main body facing the stopper contact each other, and displacement of the operation portion in a pressing direction is restricted.

5. The connector housing according to claim 1, wherein
the slide lever has a lifting portion disposed on a side of the arm in the support portion forming direction, and
by pressing down (displacing) the slide lever operation portion in the support portion forming direction, the lifting portion is displaced in the direction opposite to the support portion forming direction to lift and displace the arm.

6. The connector housing according to claim 1, wherein
the housing has two opposing wall portions on both left and right sides of the housing lever,
the slide lever has two outer walls each facing the wall portions, and
the slide lever is movable in the engagement direction and the disengageable direction by disposing the opposing wall portions and outer walls in parallel.

7. The connector housing according to claim 1, wherein
the slide lever has a guide target portion,
the housing has a guide portion, and
the guide target portion and the guide portion are movably attached, so that dropping of the slide lever is restricted.

8. The connector housing according to claim 1, wherein the main body and the housing lever are integrated.
